(19) United States
(12) Patent Application Publication
(10) Pub. No.: US 2024/0315502 A1
(43) Pub. Date: Sep. 26, 2024

(54) CLEANING SUPPORT DEVICE AND METHOD OF USE

(71) Applicant: Elizabeth Ann Feeley, Greenfield, MA (US)

(72) Inventor: Elizabeth Ann Feeley, Greenfield, MA (US)

(21) Appl. No.: 18/028,209

(22) PCT Filed: Sep. 23, 2021
(86) PCT No.: PCT/US2021/051835

§ 371 Date: Mar. 23, 2023

(51) Int. Cl. A47L 1/00; F16M 11/22

(52) U.S. Cl. CPC A47L 1/00; F16M 11/22

(57) ABSTRACT

A support device and associated method of use may be used for supporting a surface to be cleaned, such as a tilt-in window, and associated cleaning supplies. The support device may include at least one protective support feature or surface, such as a top cushion. The support device may also include at least one support feature for supplies, such as an attachment ring and/or a bag or other supply receptacle. The support device may include a plurality of legs, such as two front legs and two back legs, and the legs may be foldable or compressible for moving or storage of the support device. Pairings of legs may further include locking features or other support arms or similar features. The support device may be configured to support one or more elements of a tilt-in window when those elements are in an open configuration, enabling easier cleaning of the window.

### BACKGROUND

The present disclosure relates generally to a support device. More particularly, the present disclosure relates to a support device for aiding in cleaning surfaces which may have a rotational, pivoting, or other orientation-adjustment feature, and associated methods of use. The support device may be configured for use with tilt-in windows and may be configured to support a window, window components, cleaning products, cleaning supplies, and other elements related to such cleaning.

Many professional cleaning and maintenance workers, as well as individuals such as homeowners or renters, face a number of challenges when cleaning windows. Tilt-in windows are used in many newer constructions and renovations for a variety of reasons, including ostensibly making cleaning of the windows easier for a user, whether that user be a resident, professional cleaning service, or other users. However, even the cleaning of tilt-in windows is often found to be cumbersome and, for many individuals, overwhelming. Current processes can also be inefficient when requiring additional users to provide support of a window or of cleaning supplies during cleaning.

Tilt-in windows, despite having partial support from the window frame and building structure itself, are very heavy. The joints of the tilt-in window are strained when tilted inwards, particularly when an upper and lower window are both tilted in, may not rest at a height, angle, or orientation which is conducive to cleaning by many users, and may further complicate cleaning when necessary cleaning products and tools may be out of reach of a single user attempting to clean the windows alone, sometimes while also providing support to the window or frame itself.

The user may themselves be supporting weight of the window with one hand while attempting to wash the window with the other hand. This may make actual cleaning much more difficult, may make it more difficult to access cleaning supplies, tools, or drying products while performing the cleaning and support, and may create dangerous scenarios for a user or for the windows themselves. The sashes of a tilt-in window may be very heavy, which poses a significant problem when both the upper sash and the lower sash are opened inward for washing simultaneously.

A significant challenge when cleaning tilt-in windows while supporting them in an open configuration is having access to the cleaning products and tools. The user needs to support the window, access the spray cleaner or other cleaning products, apply the cleaner onto the window, and then be able to wipe the window clean, whether using a tool such as a squeegee, towels, or other means. Cleaning windows this way is problematic if one hand is supporting one or more sashes. Access to the cleaning-related products is also an issue when one hand is supporting one or more sashes. Many people often use their legs or hips to support the windows so as to free up both hands to spray and wipe the windows, while risking discomfort, pain, or injury from this method of use. In addition to significant risk of injury to a user, there is risk of damage to the window or sash, such as where adequate support is not maintained.

Current devices and methods of cleaning windows do not account for the difficulties in cleaning tilt-in windows while supporting the windows themselves, having access to cleaning products and tools, and being able to effectively and with little risk use the products and tools. There is a need for a device which can safely and easily be used by an individual to clean tilting surfaces such as tilt-in windows.

### SUMMARY

The present disclosure relates generally to a support device. More particularly, the present disclosure relates to a support device for aiding in cleaning surfaces which may have a rotational, pivoting, or other orientation-adjustment feature, and associated methods of use. The support device may be configured for use with tilt-in windows, as well as other devices and items which may require similar support, and may be configured to support a window, window components, cleaning products, cleaning supplies, and other elements related to such cleaning. The support device may include features for supporting a tilt-in or configurable window when in an open or partially open configuration, may include features for supporting one or more sashes, and may include features or elements for supporting or storing cleaning products or cleaning tools.

The support device may be configured to support the upper sash of a tilt-in window, the lower sash of a tilt-in window, or both. The support device may include one or more surfaces or features configured to safely receive and/or support the one or more sashes, such as a cushioned top or other padded surface or feature. The support device may include features, elements, or components configured to receive, support, and provide access to cleaning products, cleaning tools, and other supplies which may be beneficial to a user while cleaning a window. The support device may be portable, so as to be movable from one window location to another window location, optionally including storage features for the cleaning supplies during transportation or when not actively in use.

A user may select desired attachments for the support device according to the cleaning products the user chooses. Attachments may be configured to support or otherwise enable or aid in the use of paper towels, newspapers, fiber cloth, spray cleaner, one or more squeegees, and other products of a user's choice. A user may position the support device to align with the middle of the window and at a distance from the window approximately the length of the window sash, or at other distances or locations as desired. One or more of the legs of the support device may be fully deployed or may be only partially deployed, such as through rotational positions or telescopic extension, to fit the desired location of the support device or the present surface on which the support device is located, whether the surface be substantially flat, angled, or include features such as steps or a ledge. A user may follow the operating instructions of the window manufacturer to engage the lower sash to be opened in the tilt-in position, then resting the frame of the lower sash or other feature of the window on the support device, such as on a cushion feature, and then a user may clean the outer or distal side of the window.

Similarly, a user may follow the operating instructions of the window manufacturer to engage the upper sash, or other feature or element of the window, to be opened in the tilt-in position. A user may rest the frame of the upper sash on the frame of the lower sash with the invention supporting both sashes or directly on the cushion feature. The user may then clean the outer, or distal, side of the upper window. The user has easy access to cleaning products which are positioned on or otherwise in direct or indirect connection to the invention.

Once a user has completed washing one of or both of the lower and upper sashes, if so desired, the user may close the windows according to the window manufacturer instructions and return both sashes, or selected components, to their original positions. The user then may pick up the support device by the handle or by one or more other present features of the support device and move to the next window that needs to be cleaned, if desired, or, if finished with the task of cleaning the windows, the user may optionally fold the support device or otherwise return it to an undeployed configuration, carry it by the handle or other feature, and store the support device for future use. Cleaning supplies or other associated materials may be removed from the support device or may be left in the support device or in associated components for later use.

The support device may be configured for cleaning surfaces, such as rotatable or pivotable surfaces, or other adjustable surfaces, such as tilt-in windows. The support device may be configurable between an undeployed configuration and a deployed configuration, such that an undeployed device may optionally be moved to be in proximity of a surface to be cleaned, and may then be deployed. When the cleaning is completed, the device may be moved to the next location while in the deployed configuration, or may be placed back in the undeployed configuration and moved to the next surface to be cleaned or it may be stored for later use.

The support device may include a base, which may itself have a top side with a top surface and a bottom side with one or more features or additional surfaces. The base may optionally include a padded feature or a cushioning feature, such as a cushion for providing support to an item, such as a window or window sash, which may be placed upon it or at least partially rested against it. The cushioning feature may extend over substantially all of the top surface of the base, may extend beyond the top surface of the base, or may be smaller than the top surface of the base. The cushioning feature may extend to at least partially cover at least one side of the base, or one or more separate cushioning features may optionally cover at least part of at least one side of the base. The top surface of the base may optionally include a coating, treatment, other features, or be made of a material so as to minimize scratching of a surface or item laid on the top of the base or at least partially against it. The base itself, or a feature or component on the top surface of the base, may be made of a material which is elastically deformable so as to provide cushioning, protection, or to at least partially surround or otherwise support an item or feature laid on the top surface of the base or at least partially against the top surface of the base.

The support device may have a first frame, which may include a single leg, a pair of legs, or more legs. The support device may have a second frame, which may similarly include two legs, or more or fewer legs. Each of the frames may include one or more cross members, or one or more cross members may optionally extend between frames. One or both of the frames may be connected to the bottom side of the base. The base itself may optionally include a cushion feature on or near the top surface, may include additional or alternate materials for protecting window materials which may be placed upon it, or may have a separate cushion.

The support device may include at least one leg base component, which may be used to connect the first frame to the base, the second frame to the base, or both frames to the base. The support device may also include at least one spreader arm. The spreader arm may extend from any portion or component of the first frame to any portion or component of the second frame. The spreader arm may be configured to at least partially support the positioning of the second frame relative to the first frame when in a desired orientation, such as when the support device is in a deployed configuration. The spreader arm may also be configured to limit the distance of the first frame relative to the second frame, such as when in a deployed configuration, such as when looking at the bottom or “foot” of a leg of the first frame relative to the bottom or “foot” of a leg of the second frame. The spreader arm may include at least one locking feature to aid in retaining the support device in a deployed configuration. The spreader arm may also optionally be pivotably coupled to the first frame, the second frame, or both. The spreader arm may also optionally be removably connectable to at least one of the first frame or the second frame.

When in a deployed configuration, the support device may be configured so as to enable the top surface of the base to be substantially parallel to the floor or other surface on which the support device is located. The support device may also optionally be configured to enable adjustment of the angle of the top surface of the base relative to the floor, such as where the floor may be uneven, at an angle, have holes or proud features, include steps, one or more ledges, or other optionally uneven features for which the support device may need to be adjusted.

In some embodiments, the first frame or the second frame may be fixedly coupled to the leg base. In some embodiments, the second frame or the first frame may be rotatably coupled to the leg base. In some embodiments, either the first frame, the second frame, or both may be partially fixedly coupled and partially rotatably coupled to the leg base. The leg base may be substantially planar, and may include one or more attachment features, such as a screw hole. In some embodiments, the leg base may include one or more flanges which may optionally extend outwards from the primary footprint of the leg base. The one or more flanges may optionally include one or more screw holes, or the screw holes may be in the primary leg base body. The leg base may include at least one hinge feature, such as for optionally rotatably connecting a leg or frame to the leg base. The leg base may optionally include one sleeve feature or another feature for optionally fixedly connecting a leg or frame to the leg base. In some embodiments, the device may include two or more leg bases. In some embodiments, a leg base may include both a sleeve and a hinge, while in other embodiments a leg base may include one or more sleeves, while a second leg base may include one or more hinges. In other embodiments, there may be a plurality of leg bases, such as where a leg base only holds a single leg or frame through a single sleeve, or where a single leg base connected to only one leg or frame through a hinge feature. In some other embodiments, the leg base may only connect a leg or frame fixedly, while one or more legs or frames may be located within a partially open volume under the device base without connection to a hinge. It should be understood that a leg itself may comprise a sleeve feature, while the leg base may comprise a proud feature, such as a post, configured to be received by the leg sleeve, without deviating from the scope or intent of this disclosure.

The support device may optionally include a range of accessories, such as a rolled material holder, such as for holding a roll of paper towels, shop towels, or other cleaning-related materials which commonly are made available for purchase in rolls. The rolled material holder may be connected to any one of the cross members, such as a cross member of the first frame or a cross member of the second frame. Similarly, the support device may optionally include a paper material holder, such as a newspaper holder. The paper material holder may be connected to elements of the support device similarly to those described for the rolled material holder.

The support device may optionally include a holder, hook, or other feature configured to at least partially receive and to support other cleaning supplies, such as bottles or sprayers of cleaning products, one or more wiper blades, or one or more squeegees.

Any or all of the cross members may also be configured to receive and at least partially support other types of products or tools which may be desirable to have supported by the support device. In some embodiments, one or more cross members may include at least one notch to aid in retaining supplies, such as cleaning bottles. In other embodiments, one or more cross members may include features, such as one or more notches or flanges, to aid in supporting a ring, bag, or other additional support feature for supplies or for waste from cleaning. One or more legs may also optionally include notches or other features to receive cleaning supplies or additional containers for supplies. Cross members or legs may also optionally include hooks, shelves, or other retention features.

It is to be understood that the above-mentioned steps and features and the steps and features yet to be explained hereinafter can be used not only in the respectively mentioned combinations but also in other combinations or alone without deviating from the scope, intent, or context of the present invention.

### BRIEF DESCRIPTION OF THE DRAWINGS

The invention is now disclosed in detail with reference to exemplary embodiments shown in the accompanying drawings, where:

FIG. 1 shows a front left isometric view of an embodiment of the support device of the present disclosure in an open configuration;

FIG. 2 shows a rear left isometric view of the embodiment of the support device of FIG. 1;

FIG. 3 shows a side view of the embodiment of the support device of FIG. 1 in an optional closed configuration;

FIG. 4 shows a partial bottom side isometric view of an embodiment of the support device of the present disclosure in an open configuration;

FIG. 5 shows an isometric view of the embodiment of the base component of the support device of FIG. 4;

FIG. 6 shows a front view of another embodiment of the support device of the present disclosure;

FIG. 7 shows an isometric view of a holder component of the embodiment of the support device of FIG. 6;

FIG. 8 shows a front view of an alternate embodiment of the support device of the present disclosure;

FIG. 9 shows a top view of a ring component of the embodiment of the support device of FIG. 8;

FIG. 10 shows an isometric view of a ring component of the embodiment of the support device of FIG. 8; and

FIG. 11 shows an isometric view of a ring component with attached bag component of the embodiment of the support device of FIG. 8.

### DETAILED DESCRIPTION

Exemplary embodiments of the disclosure are illustrated in the Figures and are explained in the following description in more detail, wherein identical reference numbers refer to identical, or similar, or functionally identical or similar components.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials, steps, and configurations are set forth in order to provide a thorough understanding of the illustrative embodiments. However, it will be apparent to one skilled in the art that the present invention may be practiced without the specific details or without certain steps, or in a different order of steps. In other instances, well-known features or those previously described are omitted or simplified in order not to obscure the illustrative embodiments.

Various operations may be described as multiple discrete operations, in turn, in a manner that is most helpful in understanding the present invention, however the order of description should not be construed as to imply that these operations are necessarily order dependent. In particular, these operations need not be performed in the order of presentation. In some instances, structures and devices may be shown in block diagram or flow chart form in order to facilitate describing the disclosed subject matter.

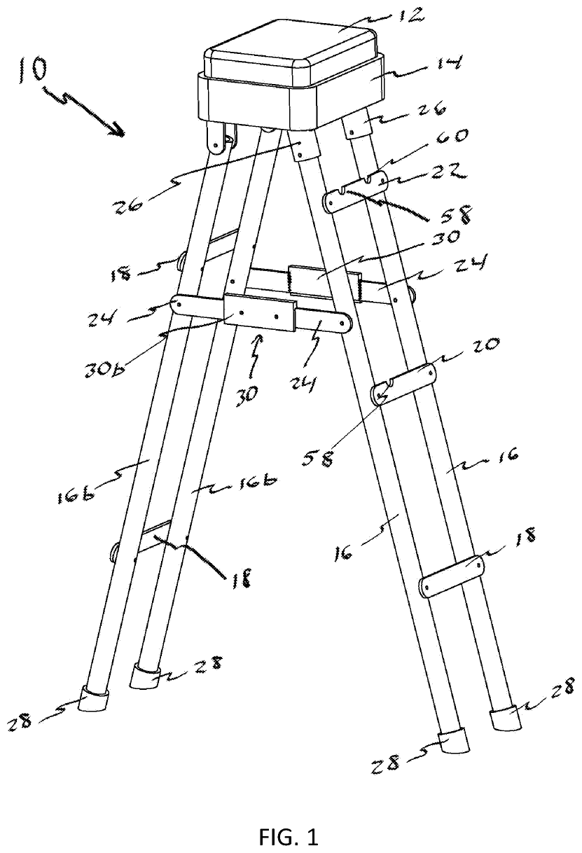

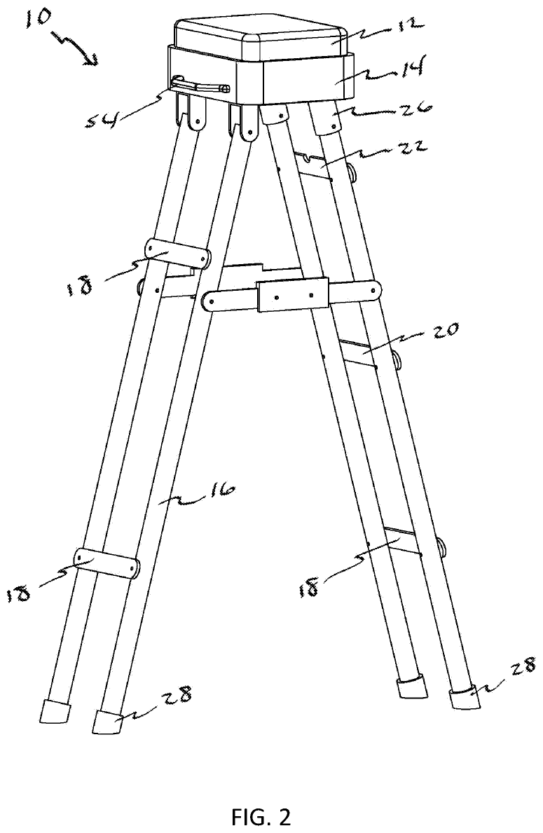

An embodiment of the support device 10 is shown in a deployed position or open configuration in FIGS. 1 & 2. The support device 10 may include a cushioned padding feature 12 or other support element which may be set into a base 14, may be integral with the base, may be connected to the base by means of screws, bolts or rivets, may be adhered to the base, or may be otherwise fixedly or removably connected to the base. The base 14 may be supported by two front legs 16 and two back legs 16b, though fewer or more front legs 16 or back legs 16b may also or alternatively be used. The front legs 16 and back legs 16b may form an assembly, may be unitary with the base 14, may be fixedly attached to the base, may be translationally attached to the base, may be rotatably attached to the base 14, or may be removably attachable to the base 14, either jointly or separately. As shown, the front legs 16 and the back legs 16b may be separated and may be connected by one or more cross members 18, 20, 22 which may provide stability and may be secured to front legs 16 and/or the back legs 16b by any suitable means, including removable fasteners such as screws or bolts, bonding, welding, pins, hinges, press fit, slip fit, snap fit, or other means known in the art. As further shown, the front legs 16 and the back legs 16b may optionally include one or more feet 28, such as on an inferior end of the legs 16, 16b, or where cushioned, protected, non-slip, or greater surface area contact with a bearing surface may be beneficial. The feet 28 may be configured to provide increased slip resistance and/or increased stability and/or decreased marring. The front legs 16 and the back legs 16b may be oriented parallel to one another, or oriented such that the rails 18, 20, 22 are spaced farther apart on the inferior end than on the superior end so as to provide additional stability.

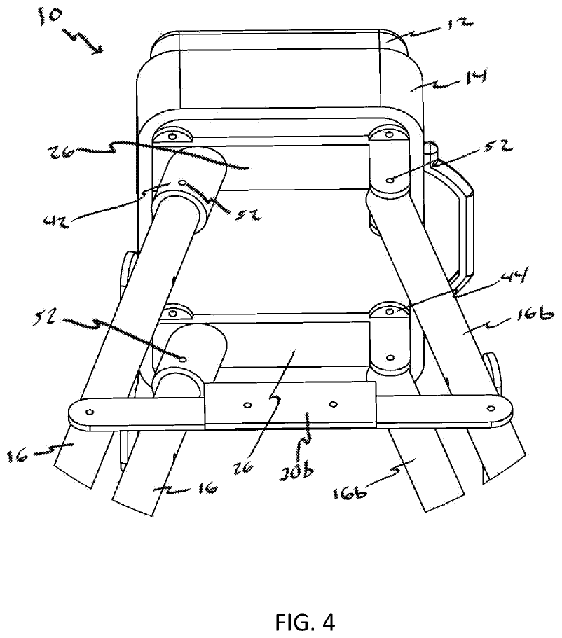

Any or all of the front legs 16 and the back legs 16b may optionally be telescopic, or include telescopic features, or some other form of mechanism to adjust the height of the support device 10. In the embodiment shown, and as shown in more detail in FIGS. 4 & 5, the front legs 16 may be inserted into sleeves 42 that may be integral with or attached to the leg base 26, and the back legs 16b may be attached to hinges 46 that may also be integral with or attached to the leg base 26. The orientation of the front legs 16 and the back legs 16b, and their respective means and points of connection, may also be reversed, combined, or omitted without deviating from the scope or intent of this disclosure.

It should be understood that other embodiments may include a leg assembly 16 which may be a unitary structure, such that the front legs 16 and one or more fixed cross members 18, 20, 22 are a single component. Such a unitary frame could be constructed, for example, from various known polymers through various known molding techniques, or from fiber-reinforced plastics, or from various composite materials such as aluminum or carbon fibers, or other metals, plastics, or composites, or combinations thereof, known in the art. It should further be understood that alternate embodiments may include similar forms of the back legs 16b, or both the front legs 16 and the back legs 16b.

A spreader arm 30 may optionally extend between one or more of the front legs 16 and the back legs 16b. The spreader arm 30 may further include additional components, such as one or more arms 24 and one or more spreader locks 30b. The spreader arm 30 may be pivotally connected to one or both of the front legs 16 and the back legs 16b, may be slidably attachable, may be extendable between the front legs 16 and the back legs 16b, or may be omitted entirely.

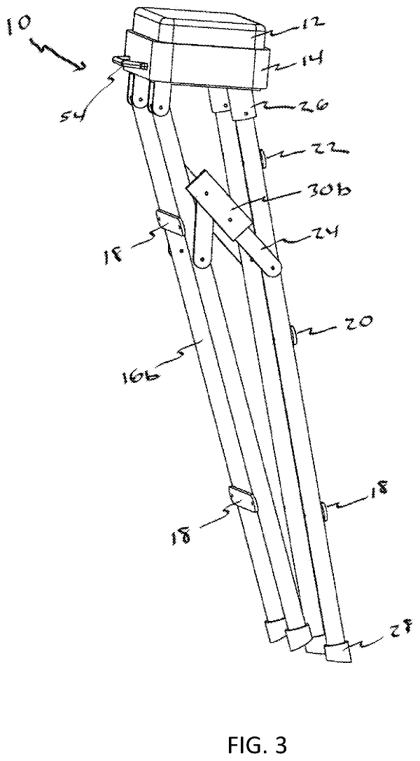

The support device 10 may include an optional handle 54, as shown in FIG. 3. In the embodiment shown, the handle 54 is attached to the base 14, though it should be understood that the handle 54 may be attached to the remainder of the support device 10 at any point or feature, such as a leg 16, 16b, rail 18, 20, 22, or the cushion 12, may be removably attachable, or may be omitted.

An embodiment of the support device 10 is shown in a closed configuration in FIG. 3. In the embodiment shown, the front legs 16 and the back legs 16b may be closer together at their inferior ends when in a closed configuration, such as where the one or more feet may be touch, or where the front legs 16 may at least partially fit in between the back legs 16b, or vice versa. Any of the legs 16, 16b may optionally include a pivot or translation feature to aid in one leg frame 16, 16b fitting at least partially within the other leg frame 16b, 16. The spreader arm 30, where present in an embodiment, may also at least partially detach or, as shown, at least partially fold, wherein at least one spreader lock 30b rotates relative to at least one arm 24. In other embodiments, the spreader arm 30 may be a unitary component which may connect to one or both of the legs 16, 16b in a removable manner, such as over a pin, by snap fit, by a press fit, or by a slip fit. On some embodiments, the spreader arm 30 may be rotatably connected to one leg 16, 16b while fitting into or over a mating feature in the other leg 16b, 16 so as to create a locked open configuration, while in some other embodiments the spreader arm 30 may removably connect to both legs 16, 16b to create a locked open configuration, such as over a pin feature or other mating feature. The spreader arm 30 may also, in some other embodiments, be configured to lock the device 10 in a closed configuration, such as where the spreader arm lock 30b may have two locking positions or where a leg 16, 16b may have at least one feature configured to receive a mating feature of the spreader arm 30 so as to retain the device 10 in a closed configuration.

A partial bottom view of an embodiment of the support device 10 is shown in FIG. 4, in an at least partially open configuration. One or more leg bases 26 may be attached to the base 14, such as at one or more flanges 44. The one or more leg bases 26 may connect to a bottom surface 14b of the base 14 or may connect or seat at least partially within an at least partially open volume 14c within the bottom of the base 14. The back leg assembly 16b may be attached to the leg base 26 by the hinges 52. As noted in FIG. 1, the front leg assembly 16 may be inserted into one or more sleeves 42 of the leg base 26. The front leg assembly 16 and/or the back leg assembly 16b may be secured to the leg base 26 by any suitable means, including removable fasteners such as screws or bolts 52, bonding or welding. The leg base 26 may be secured to the base 14 by any suitable means, including removable fasteners such as screws or bolts 52, bonding or welding.

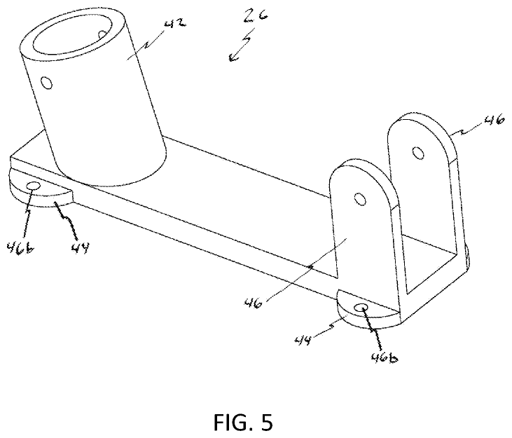

An embodiment of the leg base component 26 is shown in FIG. 5. In the embodiment shown, the leg base 26 may include one or more sleeves 42, one or more hinges 46, and one or more flanges 44, or any combination of these components may be absent. The base component 26 may be secured to the base 14 by any suitable means, including removable fasteners such as screws or bolts, bonding or welding. The leg base 26 may comprise a unitary structure, such that the sleeve 42, the flanges 44, and the hinge 46, or any combination thereof, are a single or unitary component. Such a unitary frame could be constructed, for example, from various known polymers through various known molding techniques, or from fiber-reinforced plastics, or from various composite materials such as aluminum or carbon fibers.

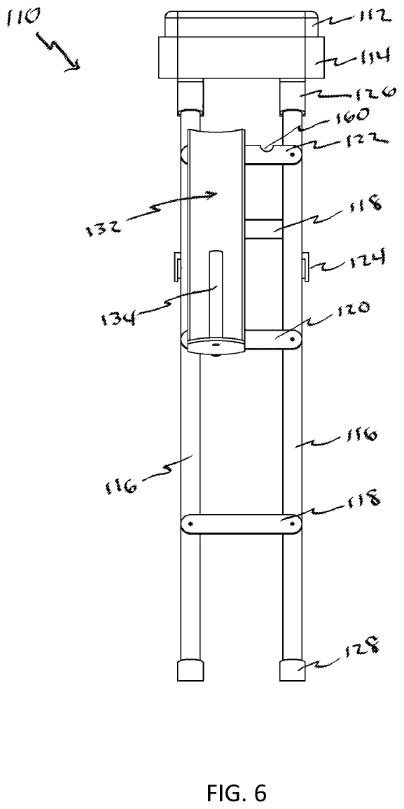

An alternate embodiment of the support device 110 is shown in FIG. 6. The support device 110 may include one or more rolled material support features 132, such as for holding paper towels or shop towels. The paper towel support feature 132 may be attached to utility cross member 122 or to any other suitable element or feature of the support device 110. A groove 160 is depicted on the utility cross member 122 that may be configured to support other products, such as those with handles, clips, or compressible features, such as a bottle of spray cleaner, or other cleaning products. A plurality of grooves 160 may be present on the cross member 122 or on other elements of the support device 110, or the grooves 160 may be entirely omitted.

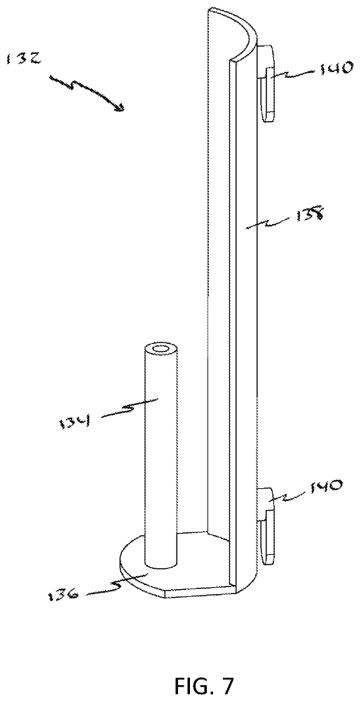

The holder component 132 of the support device 110 is shown in FIG. 7. A roll of paper towels or other rolled material may be placed over the tube 134 and rest on the optional platform 136. It should be understood that the tube 134 may be at least partially hollow, may be a solid cylinder, may be a different solid shape, such as being rectangular or hexagonal in cross-section, may be a different at least partially hollow shape, may be a hybrid shape, or may be a different shape in cross-section. The optional back panel 138 may have one or more fasteners 140 configured to attach the paper towel holder 132 to one or more utility cross members 120, 122 or to other elements of the support device 110, such as by means of a press fit, a slip fit, resting on or within a groove 160 or resting on or at least partially over or around a cross member 118, 120, 122. In some other embodiments, the holder component 132 may feature an opening or other feature configured to at least partially receive a hook, peg, or other feature or component of the device 110 in order to aid in retaining the holder component 132 in position relative to the remainder of the device 110.

It should be understood that in some embodiments, the paper towel holder 132 may have separate attached or attachable components, such as the tube 134, the platform 316, the back panel 138, and the one or more fasteners 140. The entire paper towel holder 132, or separate groupings of features or elements, may also be unitary. The paper towel holder 132 or any selection of components may be made from a range of materials known in the art, such as metals, plastics, polymers, reinforced materials, such as those using aluminum or carbon fibers, hybrid materials, or combinations of such materials.

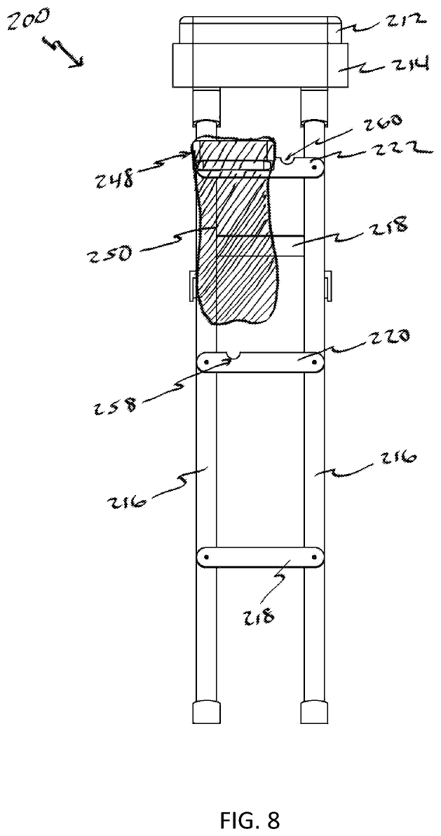

An alternate embodiment of the support device 210 is shown in FIG. 8. In this embodiment, the support device 210 optionally includes a ring feature 248, which may be a separate component or may be unitary with at least one other component or feature of the support device 210. The ring 248 may be configured to hold newspapers, cleaning items, or other items which a user may desire to have readily accessible while using the support device 210. The ring 248 may further include or be connected to a bag component 250 or other receptacle feature or component, such as a shelf or cup-holder style of component or feature. In the embodiment shown, the bag 250 is removably connected to the ring 248, though the connection may also optionally not be removable. The bag 250 may be of any fabric material, netting, plastic or other material that may be used to contain objects. As shown, the ring 248 is attached to the utility cross member 222, though it should be understood that it may be optionally connected or connectable to other components or features of the support device 210.

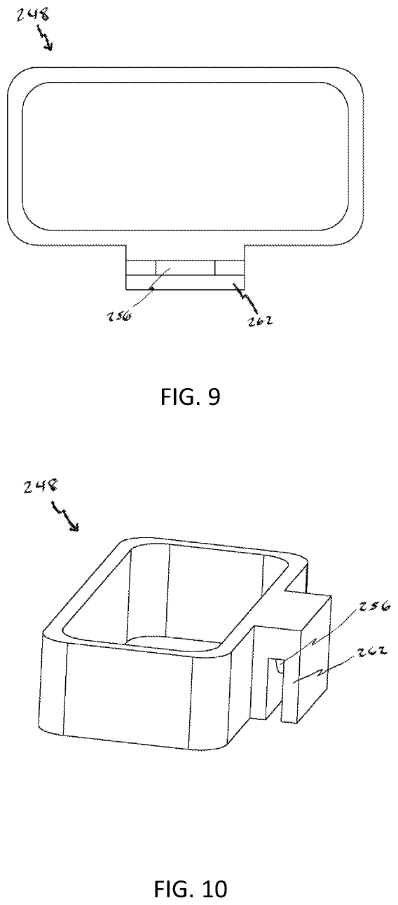

One embodiment of the ring component 248 is shown in FIGS. 9 & 10. The ring 248 may include a clip feature 262 which may fit at least partially over or otherwise connect to the utility cross member 222 or a mating feature on the support device 210. A tab 256 may snap into a notch 258 located on utility cross member 222. The ring 248 may be attached to the utility cross member 222 by any suitable means, including snap-fit, light press-fit, friction-fit, pin, using a ball plunger, rest in place from weight and configuration of mating features, or through other means known in the art without deviating from the scope or intent of this disclosure.

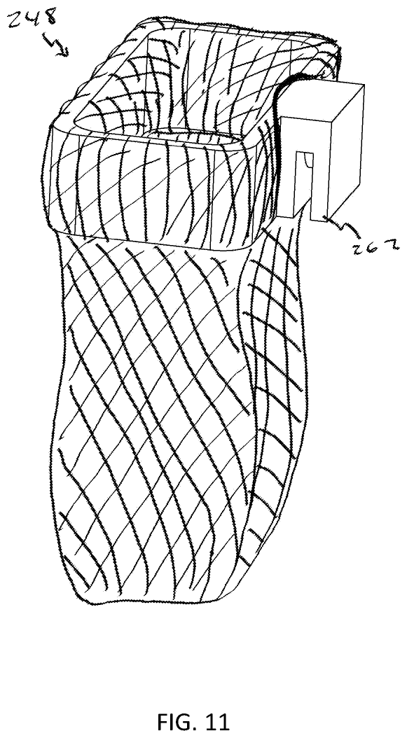

An embodiment of the ring 248 with an attached bag 250 is shown in FIG. 11. The bag 250 may be attached to the ring 248 by any suitable means, such as friction-fit, snap-fit, tying in place, or other means known in the art. It may also be at least partially held in place by means of a flexible or elastic component, such as a sealing ring or an elastic band or similar item, or by elasticity of the bag 250 itself, or may be at least partially tied into place, such as by means of a string or rope. The bag 250 may also be held in place, such as where the bag 250 is mesh or includes one or more holes or rings, by means of hooks or one or more other proud features of the ring 248. The elastic, tying, or other attachment means may be removably connectable to the bag 250 or the ring 248 or may be integral with either component 248, 250. It should be understood that the bag 250 itself may not be unitary, but may comprise other materials or components, such as connection means at the top of the bag 250 and/or reinforcing materials or features at various locations of the bag 250 itself.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention. Accordingly, various modifications, adaptations, combinations, and alternatives may occur to one skilled in the art without departing from the spirit of the invention and scope of the claimed coverage.

1. A support device for cleaning surfaces, comprising:
a base, further comprising a top surface and a bottom side;
a first frame, further comprising a first pair of legs; and
a second frame, further comprising a second pair of legs;
wherein the support device is configurable between a first undeployed configuration and a second deployed configuration, the first frame comprises at least one first cross member, the second frame comprises at least one second cross member, the first frame is connected to the bottom side, the second frame is connected to the bottom side, and the top surface comprises at least one cushion feature configured to receive and retain the weight of a window without damage to the window.

2. The support device according to claim 1, further comprising at least one leg base component connecting at least one of the first frame and the second frame to the base, and further wherein the cushion feature is a padded cushion directly connected to the base.

3. The support device according to claim 2, further comprising at least one spreader arm extending from the first frame to the second frame and configured to support the position of the first frame relative to the second frame when the support device is in the second deployed configuration.

4. The support device according to claim 1, further wherein the top surface is substantially parallel to a floor surface on which the support device is located when the support device is in the second deployed configuration.

5. The support device according to claim 3, further wherein the at least one spreader arm is pivotably coupled to at least one of the first frame and the second frame.

6. The support device according to claim 2, further comprising a rolled material support feature connected to the support device at a first support cross member and connected to the support device at a second support cross member.

7. The support device according to claim 2, further comprising a slotted bottle support feature on a first support cross member.

8. The support device according to claim 2, further comprising a netted material retention component connected to the support device at a first support cross member.

9. A support device for cleaning tilt-in windows, comprising:
a base, further comprising a top surface and a bottom side;
a first frame, further comprising a first pair of legs;
a second frame, further comprising a second pair of legs;
a leg base;
a spreader arm; and
a rolled material holder;
wherein the support device is configurable between a first undeployed configuration and a second deployed configuration, the first frame comprises at least one first cross member, the second frame comprises at least one second cross member, the base further comprises a cushion feature, proximal to the top surface, the first frame is connected to the bottom side through the leg base, the second frame is connected to the bottom side through the leg base, the spreader arm is coupled to both the first frame and the second frame, and the rolled material holder is connected to at least one of the at least one first cross member or the at least one second cross member.

10. The support device according to claim 9, further wherein at least one of the at least one first cross member or the at least one second cross member further comprises at least one connection feature configured to enable connection of optional accessories to the support device.

11. The support device according to claim 9, further wherein the rolled material holder is connected to at least one of the at least one first cross member or the at least one second cross member and comprises a cylindrical feature extending from either a back surface of the rolled material holder or a bottom surface of the rolled material holder.

12. The support device according to claim 3, further wherein the at least one spreader arm further comprises at least one locking feature which limits the distance of a first most distal portion of the first frame relative to a second most distal portion of the second frame when the support device is in the second deployed configuration.

13. A method of using a support device for cleaning tilt-in windows, comprising:
locating the support device proximal to a first tilt-in window;
deploying the support device into an open configuration;
locking one or more legs of the support device in the open configuration;
opening the first tilt-in window; and
resting a component of the first tilt-in window on a base component of the support device;
wherein the base component of the support device comprises a cushion feature.

14. The method of claim 13, further wherein the support device further comprises at least one cleaning material holding feature configured to receive and at least partially support a roll of rolled paper material.

15. The method of claim 13, further wherein the support device further comprises at least one cleaning material holding feature configured to receive and at least partially support at least one bottle of cleaning liquid.

16. The method of claim 14, further wherein the support device further comprises at least one waste material receptacle feature, further wherein the at least one waste material receptacle feature comprises a bag.

17. The method of claim 13, further wherein the support device further comprises a supply retention feature, and further wherein the supply retention feature defines a receiving open, and further wherein the supply retention feature comprises a net feature for retaining supplies.

18. The method of claim 13, further comprising opening a second tilt-in window and resting a component of the second tilt-in window on the support device.

19. The method of claim 18, further wherein the second tilt-in window rests on the cushion feature when the second tilt-in window is in an open configuration.

20. The method of claim 18, further wherein the second tilt-in window rests on the first tilt-in window when the second tilt-in window is in an open configuration.
